(19) United States
(12) Patent Application Publication
(10) Pub. No.: US 2011/0107317 A1
(43) Pub. Date: May 5, 2011

(54) Propagating Firmware Updates In A Raid Array

(75) Inventors: Michael H. Nolterieke, Raleigh, NC (US); William G. Pagan, Durham, NC (US)

(73) Assignee: INTERNATIONAL BUSINESS MACHINES CORPORATION, ARMONK, NY (US)

(21) Appl. No.: 12/609,417

(22) Filed: Oct. 30, 2009

(51) Int. Cl. G06F 9/44; G06F 12/16

(52) U.S. Cl. 717/168; 711/114; 711/E12.103

(57) ABSTRACT

Propagating firmware updates in a RAID array including identifying, by a RAID controller, that a first drive has a firmware that is uplevel with respect to firmware of at least one other drive, the RAID controller comprising a module of automated computing machinery; selecting, by the RAID controller, a second drive having downlevel firmware with respect to the firmware of the first drive; obtaining, by the RAID controller, an uplevel firmware image from the first drive; and updating, by the RAID controller, the downlevel firmware on the selected second drive with the obtained firmware image.

### BACKGROUND OF THE INVENTION

1. Field of the Invention

The field of the invention is data processing, or, more specifically, methods, apparatus, and products for propagating firmware updates in a RAID array.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is data storage. ‘RAID’ is an acronym first used to describe a redundant array of inexpensive disks, a technology that allows computer users to achieve high levels of storage reliability from low-cost and less reliable PC-class disk-drive components by arranging the devices into arrays for redundancy. More recently, the term RAID is used to mean a redundant array of independent disks. “RAID” is now used as an umbrella term for computer data storage schemes that can divide and replicate data among multiple hard disk drives. The individual drives of a RAID array have installed upon them firmware for facilitating I/O activity between the RAID drives and a RAID controller. When new drives are added to a RAID array, the firmware of the new drives may be newer than the firmware of older drives.

### SUMMARY OF THE INVENTION

Propagating firmware updates in a RAID array including identifying, by a RAID controller, that a first drive has a firmware that is uplevel with respect to firmware of at least one other drive, the RAID controller comprising a module of automated computing machinery; selecting, by the RAID controller, a second drive having downlevel firmware with respect to the firmware of the first drive; obtaining, by the RAID controller, an uplevel firmware image from the first drive; and updating, by the RAID controller, the downlevel firmware on the selected second drive with the obtained firmware image.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in propagating firmware updates in a RAID array according to embodiments of the present invention.

FIG. 2 sets forth a flow chart illustrating an exemplary method of propagating firmware updates in a RAID array according to embodiments of the present invention.

FIG. 3 sets forth a flow chart illustrating an additional method of propagating firmware updates in a RAID array according to embodiments of the present invention.

### DETAILED DESCRIPTION OF EXEMPLARY EMBODIMENTS

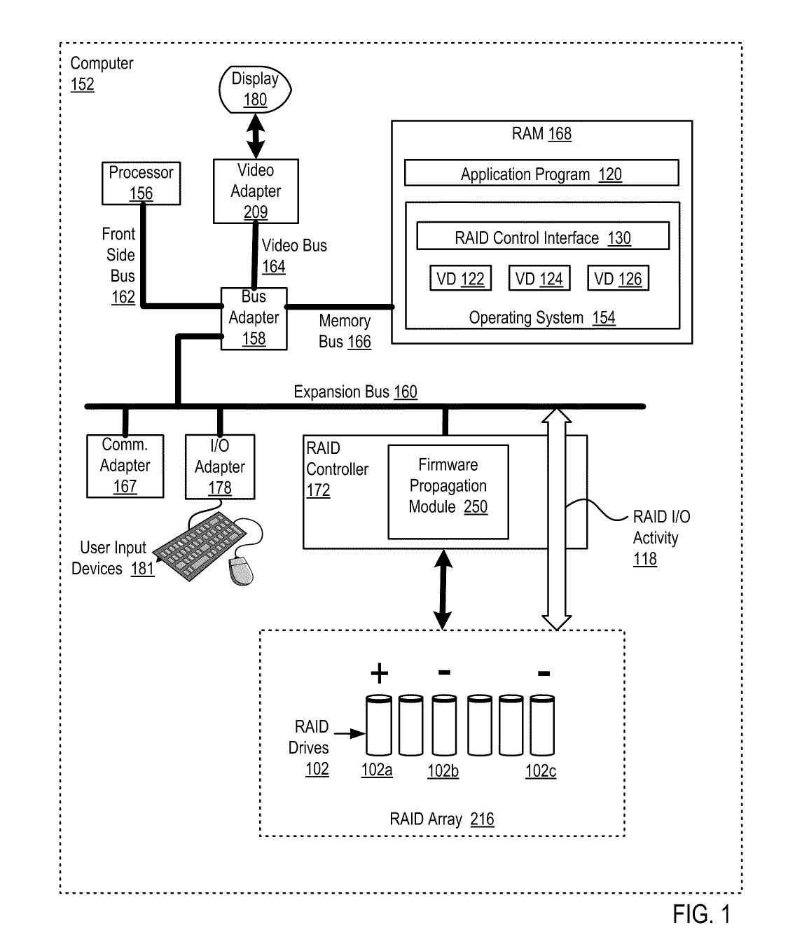

Exemplary methods, apparatus, and products for propagating firmware updates in a RAID array in accordance with the present invention are described with reference to the accompanying drawings, beginning with FIG. 1. FIG. 1 sets forth a block diagram of automated computing machinery comprising an exemplary computer (152) useful in propagating firmware updates in a RAID array according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is an application program (120), a module of user-level computer program instructions for carrying out particular data processing tasks on the computer (152). Examples of such application programs include spreadsheets, word processing programs, email clients, web browsers, database management programs, and so on.

Also stored in RAM is a RAID control interface (130), a module of computer program instructions that provides a application programming interface or ‘API’ through which the application program (120) can communicate with the RAID controller (172) to receive from the RAID controllers information regarding RAID input/output activity (118). Also stored in RAM are several virtual drives (122, 124, 126), modules of computer program instructions that provide APIs for use by the operating system and the application program in writing and reading data to and from RAID drives (102).

Also stored in RAM (168) is an operating system (154). Operating systems useful with propagating firmware updates in a RAID array according to embodiments of the present invention include UNIX™, Linux™, Microsoft XP™, AIX™, IBM's i5/OS™, and others as will occur to those of skill in the art. The operating system (154), the application program (120), the RAID control interface (130), and the virtual drives (122, 124, 126) in the example of FIG. 1 are shown in RAM (168), but many components of such software typically are stored in non-volatile memory also, such as, for example, on RAID drives (102).

The computer (152) of FIG. 1 includes a RAID controller (172) coupled through expansion bus (160) and bus adapter (158) to processor (156) and other components of the computer (152). The RAID controller (172) is a computer input/output adapter that connects non-volatile data storage to the computer (152) in the form of RAID drives (102). RAID controllers (172) organize RAID drives (102) into RAID arrays (216) and expose storage capacity on the RAID drives to the operating system (154) and to application programs (120) in the form of virtual drives (122, 124, 126). The RAID controller (172) of FIG. 1 administers read and write requests directed to the virtual drives (122, 124, 126) as RAID I/O activity (118) to and from the RAID drives (102).

The RAID drives (102) are organized into a RAID array (216). A RAID array operates according to one RAID specification or ‘RAID level.’ RAID levels include, for example:
RAID 0: A striped set of at least two RAID drives without parity. RAID 0 provides improved performance and additional storage but no fault tolerance from disk errors or disk failure. The striping allows smaller sections of an entire chunk of data to be read off the array in parallel, giving RAID 0 arrays large bandwidth. Hence RAID 0 arrays are fast, but they typically require additional backup to guard against disk failure.
RAID 1: A mirrored set of at least two RAID drives without parity. RAID 1 provides fault tolerance from disk errors and single disk failure. Increased read performance occurs when using a multi-threaded operating system that supports split seeks. Each array or subarray continues to operate so long as at least one drive is functioning.
RAID 3 and RAID 4: A striped set of at least three RAID drives with dedicated parity, where each parity bit represents a memory location, and each parity bit advises whether the represented memory location is empty or full, thus enhancing read and write speed. This mechanism provides an improved performance and fault tolerance similar to RAID 5, but with a dedicated parity disk rather than rotated parity stripes. The dedicated parity disk allows the parity drive to fail and operation will continue without parity or performance penalty.
RAID 5: A striped set of at least three RAID drives with distributed parity. Distributed parity requires all but one drive to be present to operate, although RAID functionality is not destroyed by a single drive failure. Upon drive failure, any subsequent reads can be calculated from the distributed parity so that the drive failure is masked from the end user.
RAID 6: A striped set of at least four RAID drives with dual distributed parity. RAID 6 provides fault tolerance from two drive failures; each array continues to operate with up to two failed drives. This makes larger RAID groups more practical, especially for high availability systems.

Composite RAID levels include, for example:
RAID 0+1: A striped set of RAID drives and a mirrored set of RAID drives comprising an even number of at least four disks—provides fault tolerance and improved performance but increases complexity. The key difference from RAID 1+0 is that RAID 0+1 creates a second striped set to mirror a primary striped set.
RAID 1+0: A mirrored set of RAID drives plus a striped set of RAID drives comprising at least four drives—provides fault tolerance and improved performance but increases complexity. The key difference from RAID 0+1 is that RAID 1+0 creates a striped set from a series of mirrored drives.
RAID 5+0: A stripe across distributed parity RAID systems.
RAID 5+1: A mirror striped set with distributed parity, sometimes characterized as RAID 5+3.

Each of the RAID drives (102) of FIG. 1 includes firmware installed on the drive to facilitate I/O activity. Newer RAID drives (102) may include firmware that is uplevel—that is, a more recent version—than older RAID drives. The RAID controller (172) of FIG. 1 includes a firmware propagation module (250) capable of propagating firmware updates in a RAID array according to embodiments of the present invention. The firmware propagation module (250) includes computer program instructions for identifying that a first drive (102a) has firmware that is uplevel with respect to the firmware of at least one other drive (102b and 102c). The term ‘uplevel’ in this specification is used to mean a more recent version release of the firmware. The term ‘downlevel’ is used to mean a version of the firmware which is older with respect to another version. In the example of FIG. 1, a ‘+’ symbol is used to designate that the firmware on RAID drive (102a) is uplevel with respect to the firmware of drives (102b and 102c) designated as downlevel with the ‘−’ symbol.

The firmware propagation module (250) also includes computer program instructions for selecting a second drive (102b) having downlevel firmware with respect to the firmware of the first drive (102a), obtaining an uplevel firmware image from the first drive (102a) and updating the downlevel firmware on the selected second drive (102b) with the obtained firmware image.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers, including data communications through one or more data communications networks. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for propagating firmware updates in a RAID array according to embodiments of the present invention include modems for wired dial-up communications, Ethernet (IEEE 802.3) adapters for wired data communications network communications, and 802.11 adapters for wireless data communications network communications.

The arrangement of devices making up the exemplary computer illustrated in FIG. 1 are for explanation, not for limitation. Computers useful for propagating firmware updates in a RAID array according to various embodiments of the present invention may include additional processors, memory, I/O functionality, and other architectures, not shown in FIG. 1, as will occur to those of skill in the art. Various embodiments of the present invention may be implemented on a variety of hardware platforms in addition to those illustrated in FIG. 1.

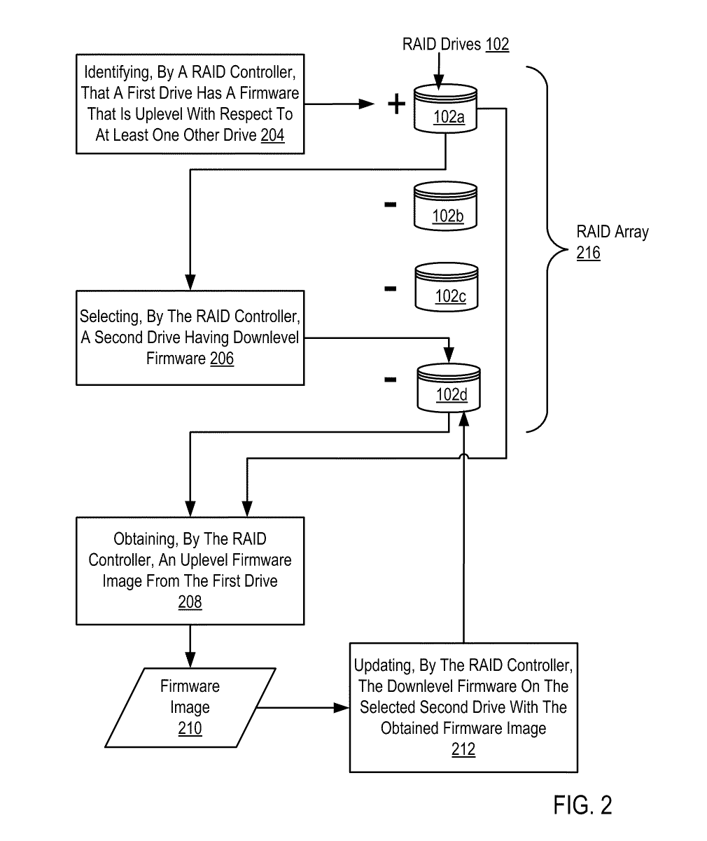

For further explanation, FIG. 2 sets forth a flow chart illustrating an exemplary method of propagating firmware updates in a RAID array according to embodiments of the present invention. The method of FIG. 2 includes identifying (204), by a RAID controller, that a first drive (102a) has a firmware that is uplevel with respect to the firmware of at least one other drive (102b, 102c, 102d), the RAID controller comprising a module of automated computing machinery. Identifying, by a RAID controller, that a first drive has a firmware that is uplevel with respect to firmware of at least one other drive may be carried out by polling, by the RAID controller the first drive upon installation of the first drive, for firmware metadata and comparing the firmware metadata with firmware metadata for at least the second drive. In some embodiments of the present invention, a RAID controller may maintain a list of version identifications of the firmware currently installed on all the RAID drives. Upon installation of a new RAID drive, the RAID controller may poll the new RAID drive for metadata describing the version of firmware on the new drive and compare that metadata with version identifications of all the other drives in the list. Alternatively, instead of maintaining a list, a RAID controller may poll each RAID drive for version identifications of the firmware currently installed on the current RAID drives upon each installation of a new drive and compare the version identifications of all the RAID drives to identify one or more RAID drives having firmware that is uplevel with respect to the firmware of one or more other RAID drives.

Identifying, by a RAID controller, that a first drive has a firmware that is uplevel with respect to firmware of at least one other drive may also be carried out by receiving, by the RAID controller of the first drive upon installation of the first drive without prompting from the RAID controller, firmware metadata and comparing the firmware metadata with firmware metadata for at least the second drive. As mentioned above, a RAID controller may maintain a list of version identifications of the firmware currently installed on all the RAID drives. Upon installation of a new RAID drive, the RAID controller may receive without prompt metadata describing the version of firmware on the new drive and compare that metadata with version identifications of all the other drives in the list.

The method of FIG. 2 also includes selecting (206), by the RAID controller, a second drive (102) having downlevel firmware with respect to the firmware of the first drive (102a). Selecting (206), by the RAID controller, a second drive (102) having downlevel firmware with respect to the firmware of the first drive (102a) may be carried out by traversing a list of RAID drives and selecting the next drive on the list having downlevel firmware with respect to the firmware of the first drive (102a).

The method of FIG. 2 also includes obtaining (208), by the RAID controller, an uplevel firmware image (210) from the first drive (102a). Obtaining (208), by the RAID controller, an uplevel firmware image (210) from the first drive (102a) may be carried out by reading from the first drive (102a) an image of the uplevel firmware. Such an image of the uplevel firmware may be in the form of an update representing a portion of the total firmware or an entire copy of the uplevel firmware.

The method of FIG. 2 also includes updating (212), by the RAID controller, the downlevel firmware on the selected second drive (102d) with the obtained firmware image (210). Updating (212), by the RAID controller, the downlevel firmware on the selected second drive (102d) with the obtained firmware image (210) may be carried out by writing the firmware image on the selected second drive.

As mentioned above, an image of the uplevel firmware obtained from the first RAID drive may be in the form of an update representing a portion of the total firmware or an entire copy of the uplevel firmware. Therefore, in some embodiments of the present invention, obtaining (208), by the RAID controller, an uplevel firmware image may be carried out by reading the entire uplevel firmware image from the first drive and updating, by the RAID controller, the downlevel firmware on the selected second drive with the uplevel firmware update may be carried out by writing the entire uplevel firmware image to the second drive. Alternatively, in other exemplary embodiments of the present invention, obtaining (208), by the RAID controller, an uplevel firmware image may be carried out by reading a portion of the uplevel firmware image from the first drive and updating, by the RAID controller, the downlevel firmware on the selected second drive with the uplevel firmware update may be carried out by writing the portion uplevel firmware image to the second drive.

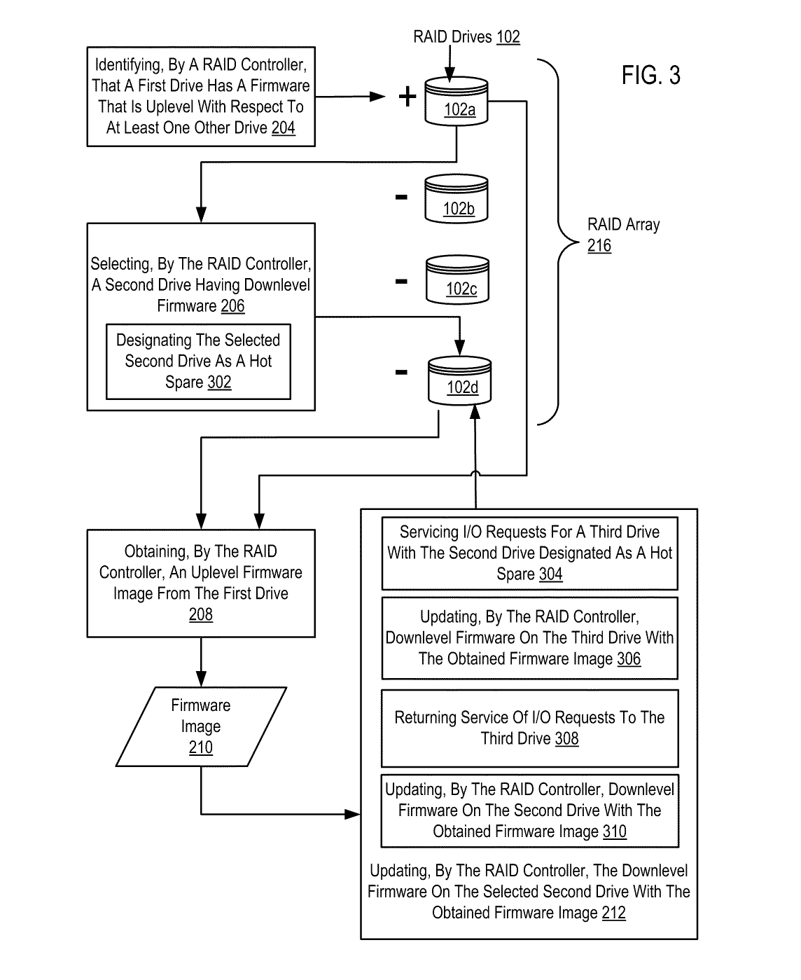

For further explanation, FIG. 3 sets forth a flow chart illustrating an additional method of propagating firmware updates in a RAID array according to embodiments of the present invention. The method of FIG. 3 is similar to the method of FIG. 2 in that the method of FIG. 3 includes identifying (204), by a RAID controller, that a first drive (102a) has a firmware that is uplevel with respect to the firmware of at least one other drive (102b, 102c, 102d); selecting (206), by the RAID controller, a second drive (102) having downlevel firmware with respect to the firmware of the first drive (102a); obtaining (208), by the RAID controller, an uplevel firmware image (210) from the first drive (102a); and updating (212), by the RAID controller, the downlevel firmware on the selected second drive (102d) with the obtained firmware image (210).

The method of FIG. 3 differs from the method of FIG. 2 in that in the method of FIG. 3, selecting (302), by the RAID controller, a second drive having downlevel firmware includes designating (302) the selected second drive (102d) as a hot spare. A ‘hot spare’ typically means a spare drive configured for automatic failover of one or more other drives. In the method of FIG. 3, designating (302) the selected second drive (102d) as a hot spare according to the method of Figure may be carried out by configuring the second drive to service I/O requests for another third RAID drive with downlevel firmware such that the third drive may be updated with the obtained uplevel firmware image.

The method of FIG. 3 also differs from the method of FIG. 2 in that in the method of FIG. 3 updating (212), by the RAID controller, the downlevel firmware on the selected second drive with the obtained firmware image includes servicing (304) I/O requests for a third drive (102c) with the second drive (102d) designated as a hot spare; updating (306), by the RAID controller, downlevel firmware on the third drive (102c) with the obtained firmware image (210); returning (308) service of I/O requests to the third drive; and updating (310), by the RAID controller, downlevel firmware on the second drive with the obtained firmware image.

The method of FIG. 3 includes servicing (304) I/O requests for a third drive (102c) with the second drive (102d) designated as a hot spare. Servicing (304) I/O requests for a third drive (102c) with the second drive (102d) designated as a hot spare may be carried out by performing by the second drive (102d) all the read and write requests directed to the third drive such that the third drive may be updated with uplevel firmware. Servicing (304) I/O requests for a third drive (102c) with the second drive (102d) provides transparent service to application programs and the operating system while allowing the firmware of the third drive to be updated.

The method of FIG. 3 also includes updating (306), by the RAID controller, downlevel firmware on the third drive (102c) with the obtained firmware image (210). Updating (306), by the RAID controller, downlevel firmware on the third drive (102c) with the obtained firmware image (210) may be carried out by writing to the third drive the firmware image obtained from the first drive. As mentioned above, writing to the third drive the firmware image obtained from the first drive may include writing all of the firmware to the third drive or writing only a portion of the firmware to the third drive such that the firmware of the third drive is updated to the same level as the firmware on the first drive.

The method of FIG. 3 also then includes returning (308) service of I/O requests to the third drive. Returning (308) service of I/O requests to the third drive may be carried out by configuring the third drive to service I/O requests currently being serviced by the second drive designated as a hot spare.

After updating the firmware of the third drive, the method of FIG. 3 includes updating (310), by the RAID controller, downlevel firmware on the second drive with the obtained firmware image. Updating (310), by the RAID controller, downlevel firmware on the second drive with the obtained firmware image may be carried out by writing the obtained firmware image to the second drive. As mentioned above, writing the obtained firmware image to the second drive may include writing all of the firmware to the second drive or writing only a portion of the firmware to the second drive such that the firmware of the second drive is updated to the same level as the firmware on the first drive.

Updating (212) downlevel firmware on the selected drives through the use of a hot spare allows service to a RAID array to continue without interruption while the firmware of individual drives are updated.

Propagating firmware has been described in this specification in the context of propagating the firmware of a RAID drive in a RAID array. The invention, however, is not limited to RAID drives. In fact, many redundant components may be updated according to additional embodiments of the present invention. For example, the firmware of a blade server may be updated by a management module of a blade server chassis. Such embodiments include a method of propagating firmware updates in a blade server chassis includes identifying, by a management module, that a first blade server has a firmware that is uplevel with respect to firmware of at least one other blade server, the management module comprising a module of automated computing machinery; selecting, by the management module, a second blade server having downlevel firmware with respect to the firmware of the first blade server; obtaining, by the management module, an uplevel firmware image from the first blade server; and updating, by the management module, the downlevel firmware on the selected second blade server with the obtained firmware image. In some embodiments selecting, by the management module, a second blade server having downlevel firmware with respect to the firmware of the first blade server includes designating the selected second blade server as a hot spare and updating, by the management module, the downlevel firmware on the selected second blade server with the obtained firmware image includes servicing requests for a third blade server with the second blade server designated as a hot spare, and updating, by the management module, downlevel firmware on the third blade server with the obtained firmware image; returning service of requests to the third blade server; and updating, by the management module, downlevel firmware on the second blade server with the obtained firmware image.

Exemplary embodiments of the present invention are described largely in the context of a fully functional computer system for propagating firmware updates in a RAID array. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernet™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of propagating firmware updates in a RAID array, the method comprising:
identifying, by a RAID controller, that a first drive has a firmware that is uplevel with respect to firmware of at least one other drive, the RAID controller comprising a module of automated computing machinery;
selecting, by the RAID controller, a second drive having downlevel firmware with respect to the firmware of the first drive;
obtaining, by the RAID controller, an uplevel firmware image from the first drive; and
updating, by the RAID controller, the downlevel firmware on the selected second drive with the obtained firmware image.

2. The method of claim 1 wherein:
selecting, by the RAID controller, a second drive having downlevel firmware with respect to the firmware of the first drive further comprises designating the selected second drive as a hot spare and
updating, by the RAID controller, the downlevel firmware on the selected second drive with the obtained firmware image further comprises:
servicing I/O requests for a third drive with the second drive designated as a hot spare; and
updating, by the RAID controller, downlevel firmware on the third drive with the obtained firmware image;
returning service of I/O requests to the third drive; and
updating, by the RAID controller, downlevel firmware on the second drive with the obtained firmware image.

3. The method of claim 1 wherein obtaining, by the RAID controller, an uplevel firmware image from the first drive further comprises reading the entire uplevel firmware image from the first drive; and
updating, by the RAID controller, the downlevel firmware on the selected second drive with the obtained firmware image further comprises writing the entire uplevel firmware image to the second drive.

4. The method of claim 1 wherein obtaining, by the RAID controller, an uplevel firmware image from the first drive further comprises reading a portion of the uplevel firmware image from the first drive; and
updating, by the RAID controller, the downlevel firmware on the selected second drive with the obtained firmware image further comprises writing the portion uplevel firmware image to the second drive.

5. The method of claim 1 wherein identifying, by a RAID controller, that a first drive has a firmware that is uplevel with respect to firmware of at least one other drive further comprises polling, by the RAID controller the first drive upon installation of the first drive, for firmware metadata and comparing the firmware metadata with firmware metadata for at least the second drive.

6. The method of claim 1 wherein identifying, by a RAID controller, that a first drive has a firmware that is uplevel with respect to firmware of at least one other drive further comprises receiving, by the RAID controller of the first drive upon installation of the first drive, firmware metadata and comparing the firmware metadata with firmware metadata for at least the second drive.

7. Apparatus for propagating firmware updates in a RAID array, the apparatus comprising a computer processor, a computer memory operatively coupled to the computer processor, the computer memory having disposed within it computer program instructions capable of:
identifying, by a RAID controller, that a first drive has a firmware that is uplevel with respect to firmware of at least one other drive, the RAID controller comprising a module of automated computing machinery;
selecting, by the RAID controller, a second drive having downlevel firmware with respect to the firmware of the first drive;
obtaining, by the RAID controller, an uplevel firmware image from the first drive; and
updating, by the RAID controller, the downlevel firmware on the selected second drive with the obtained firmware image.

8. The apparatus of claim 7 wherein:
computer program instructions capable of selecting, by the RAID controller, a second drive having downlevel firmware with respect to the firmware of the first drive further comprise computer program instructions capable of:
designating the selected second drive as a hot spare and computer program instructions capable of updating, by the RAID controller, the downlevel firmware on the selected second drive with the obtained firmware image further comprise computer program instructions capable of:
servicing I/O requests for a third drive with the second drive designated as a hot spare; and
updating, by the RAID controller, downlevel firmware on the third drive with the obtained firmware image;
returning service of I/O requests to the third drive; and
updating, by the RAID controller, downlevel firmware on the second drive with the obtained firmware image.

9. The apparatus of claim 7 wherein computer program instructions capable of obtaining, by the RAID controller, an uplevel firmware image from the first drive further comprise computer program instructions capable of: reading the entire uplevel firmware image from the first drive; and
computer program instructions capable of updating, by the RAID controller, the downlevel firmware on the selected second drive with the obtained firmware image further comprise computer program instructions capable of writing the entire uplevel firmware image to the second drive.

10. The apparatus of claim 7 wherein computer program instructions capable of obtaining, by the RAID controller, an uplevel firmware image from the first drive further comprise computer program instructions capable of reading a portion of the uplevel firmware image from the first drive; and
computer program instructions capable of updating, by the RAID controller, the downlevel firmware on the selected second drive with the obtained firmware image further comprise computer program instructions capable of writing the portion uplevel firmware image to the second drive.

11. The apparatus of claim 7 wherein computer program instructions capable of identifying, by a RAID controller, that a first drive has a firmware that is uplevel with respect to firmware of at least one other drive further comprise computer program instructions capable of polling, by the RAID controller the first drive upon installation of the first drive, for firmware metadata and comparing the firmware metadata with firmware metadata for at least the second drive.

12. The apparatus of claim 7 wherein computer program instructions capable of identifying, by a RAID controller, that a first drive has a firmware that is uplevel with respect to firmware of at least one other drive further comprise computer program instructions capable of receiving, by the RAID controller of the first drive upon installation of the first drive, firmware metadata and comparing the firmware metadata with firmware metadata for at least the second drive.

13. A computer program product for propagating firmware updates in a RAID array, the computer program product disposed in a computer readable recordable medium, the computer program product comprising computer program instructions capable of:
identifying, by a RAID controller, that a first drive has a firmware that is uplevel with respect to firmware of at least one other drive, the RAID controller comprising a module of automated computing machinery;
selecting, by the RAID controller, a second drive having downlevel firmware with respect to the firmware of the first drive;
obtaining, by the RAID controller, an uplevel firmware image from the first drive; and
updating, by the RAID controller, the downlevel firmware on the selected second drive with the obtained firmware image.

14. The computer program product of claim 13 wherein:
computer program instructions capable of selecting, by the RAID controller, a second drive having downlevel firmware with respect to the firmware of the first drive further comprise computer program instructions capable of:
designating the selected second drive as a hot spare and computer program instructions capable of updating, by the RAID controller, the downlevel firmware on the selected second drive with the obtained firmware image further comprise computer program instructions capable of:
servicing I/O requests for a third drive with the second drive designated as a hot spare; and
updating, by the RAID controller, downlevel firmware on the third drive with the obtained firmware image;
returning service of I/O requests to the third drive; and
updating, by the RAID controller, downlevel firmware on the second drive with the obtained firmware image.

15. The computer program product of claim 13 wherein computer program instructions capable of obtaining, by the RAID controller, an uplevel firmware image from the first drive further comprise computer program instructions capable of: reading the entire uplevel firmware image from the first drive; and
computer program instructions capable of updating, by the RAID controller, the downlevel firmware on the selected second drive with the obtained firmware image further comprise computer program instructions capable of writing the entire uplevel firmware image to the second drive.

16. The computer program product of claim 13 wherein computer program instructions capable of obtaining, by the RAID controller, an uplevel firmware image from the first drive further comprise computer program instructions capable of reading a portion of the uplevel firmware image from the first drive; and
computer program instructions capable of updating, by the RAID controller, the downlevel firmware on the selected second drive with the obtained firmware image further comprise computer program instructions capable of writing the portion uplevel firmware image to the second drive.

17. The computer program product of claim 13 wherein computer program instructions capable of identifying, by a RAID controller, that a first drive has a firmware that is uplevel with respect to firmware of at least one other drive further comprise computer program instructions capable of polling, by the RAID controller the first drive upon installation of the first drive, for firmware metadata and comparing the firmware metadata with firmware metadata for at least the second drive.

18. The computer program product of claim 13 wherein computer program instructions capable of identifying, by a RAID controller, that a first drive has a firmware that is uplevel with respect to firmware of at least one other drive further comprise computer program instructions capable of receiving, by the RAID controller of the first drive upon installation of the first drive, firmware metadata and comparing the firmware metadata with firmware metadata for at least the second drive.
